(19) United States
(12) Patent Application Publication
(10) Pub. No.: US 2016/0267492 A1
(43) Pub. Date: Sep. 15, 2016

(54) Systems and methods for generating cover sites and marketing tools that allow media or product owners to learn, scale, understand, track, visualize, disrupt and redirect the piracy/misuse of the media content, grey or black market goods, or counterfeit products

(71) Applicants: Wayne D. Lonstein, Ellenville, NY (US); Julie C. Lonstein, Ellenville, NY (US)

(72) Inventors: Wayne D. Lonstein, Ellenville, NY (US); Julie C. Lonstein, Ellenville, NY (US)

(21) Appl. No.: 15/065,165

(22) Filed: Mar. 9, 2016

Related U.S. Application Data
(60) Provisional application No. 62/130,087, filed on Mar. 9, 2015.

(51) Int. Cl. G06Q 30/00; G06Q 50/18

(52) U.S. Cl. CPC G06Q 30/0185; G06Q 50/184

(57) ABSTRACT

The present disclosure relates to systems and methods for creating platforms that provide product or media owners with marketing tools and information regarding their product or media and encourage, persuade, and force users who illegally or without permission access, view or otherwise use or consume the product, service or media to stop doing so, and allows them the opportunity to obtain permission and/or a license to the product, service or media in question. The method and system comprise of generating of apparent pirated or counterfeit goods or media content web sites and applications and other disruptive methods and processes.

This disclosure claims the benefit of the filing date of U.S. Provisional Application No. 62/130,087 filed on Mar. 9, 2015, the teachings and entire disclosure of which are incorporated herein by reference in their entirety.

### FIELD OF THE DISCLOSURE

The present disclosure generally relates to systems and methods for creating platforms, systems and methods that provide product or media owners with valuable marketing tools and information regarding their product or media and encourage, persuade and possibly force users who illegally or without permission access, view or otherwise use or consume the product, service or media to stop doing so and, in some embodiments, allows them the opportunity to obtain permission and/or a license to the product, service or media in question. More particularly, the present disclosure provides product, service or media owners with a platform and a variety of marketing tools and information that allows them to, among other things, learn, scale, understand, track, visualize, disrupt and redirect the potential pirate and counterfeit consumers from the piracy and misuse of their products, services, media content, grey or black market goods or counterfeit products. This is done through a variety of tools and features, including, but not limited to, the automatic generation of apparent pirated or counterfeit goods or media content web sites and applications (hereinafter referred to as “cover sites” and “straw sites”) and other disruptive methods and processes.

### BACKGROUND

Intellectual property rights are often powerful property rights granted to the owner of the intellectual property. One type of intellectual property is copyright, which provides certain rights to the creator of an original work of authorship, including literary, dramatic, musical, artistic and other intellectual works.

Generally speaking, copyright is enforced as a civil matter although some jurisdictions do apply criminal sanctions. Copyright limitations are recognized by most jurisdictions and some exceptions to the author's exclusivity of copyright are allowed giving users certain rights. However, the Internet and digital media have created new and challenging tests of the copyright laws. New technologies, including peer-to-peer (P2P) and peer-to-many (e.g., Periscope®, Meerkat®, among others), have prompted re-interpretations of the exceptions, a new surge in the fight for copyright protection and protecting the rights of media content and other proprietary goods, services and products.

Unauthorized use of protected media content, services, grey or black market goods or counterfeit products occurs when a business or individual accesses, uses or otherwise consumes media content, services, grey or black market goods or counterfeit products without permission or a license to the protected media, services or goods. Unauthorized use of protected media content is often accomplished using one of many file-sharing services (e.g., BitTorrent®), websites where users illegally download or stream protected media content without permission or a license, or peer-to-many live streaming applications, such as, but not limited to, Periscope®, Meerkat®, among others) Further, illegal activity on these services or websites is not confined to the media content. These file-sharing services or websites and other sites that market and sell physical goods also allow users to search for and obtain all types of content, including pirated software, movies, TV shows or music, black or grey market and counterfeit goods, products and services.

To protect their creative works and/or products, media or product owners are enlisting the help of infrastructure companies, including internet service providers (ISPs); credit card processors; search engines; and content monitoring companies, in an attempt to stifle theft and piracy-enabling sites by making it difficult for the users who illegally consume media content to operate and process transactions. Users of such sites then fear being caught by infrastructure companies who then provide information regarding the identity and activity of the users who illegally download content. Media content and product owners, such as motion picture studios or the record industry, are also enlisting the help of law enforcement agencies and taking legal action against known offenders. For example, the Copyright Alert System is a proactive initiative that enlists the help of ISPs to attempt to thwart media piracy. If media owners see their music, movies, TV shows or other copyrighted works being shared without permission on P2P networks, peer-to-many (e.g., Periscope®, Meerkat®, among others) this system enables them to notify the appropriate ISP of the internet protocol (IP) addresses involved. In turn, the ISP can notify the individuals with that IP address to stop the illegal file sharing. If that warning goes unheeded, the ISPs can take steps that negatively impact that subscriber's internet experience, such as reducing bandwidth or quality of service and/or the content owner can take steps to bring suit against the infringer. Unfortunately, these and other related methods have largely been unsuccessful as users who illegally consume media content have found ways to avoid getting caught, and the cost and time associated with bringing suit against these users is cost prohibitive on a large scale causing the piracy problem to continue to grow.

Despite these efforts, the number of illegal downloads of media content, the usage and purchase of black or grey market and counterfeit goods have not decreased. For example, the Institute for Policy Innovation concludes that global music piracy causes $12.5 billion of economic losses every year, 71,060 U.S. jobs lost, a loss of $2.7 billion in workers' earnings, a loss of $422 million in tax revenues, $291 million in personal income tax and $131 million in lost corporate income and production taxes, which is only a small part of the illegal media content, black or grey and counterfeit goods and services market. Piracy, misuse and other illegal online activity is routinely combatted by issuance of DMCA “takedown notices” directed to search engines, such as, but not limited to, Google® and Yahoo®, among others, or to ISPs requesting them to “take down” infringing or illegal content or links to them. In February 2016 alone, the number of such notices sent to just one company, Google®, exceeded 75 million requests.

Accordingly, there exists a need for improved platforms, systems and methods that not only prevent users who illegally consume media content from accessing protected media content, services, grey or black market goods, or counterfeit products without permission or a license, but also persuade, educate, deter or force these users to turn into lawful paying customers. There also exists a need for methods and systems that provide media content and product owners with the ability to create and scale a series of applications and/or cover sites and associated marketing tools that allow the owners to scale and understand, track, visualize and disrupt the piracy/misuse that is occurring. In doing so, media content and product owners will understand the market, how protected media content and black or grey market and counterfeit goods are consumed or used. This will allow these owners to make better decisions in marketing and product development, to prevent piracy and theft, to convert illegal consumers to legitimate consumers and, possibly, to interact directly or indirectly with users who would illegally consume this content or goods. This will further allow for better control and decision-making by the content and product owners. There also exists a need for methods and systems of deploying various applications and/or cover sites to a host of offshore or onshore servers to keep the media content or product owners completely separate from activities involving the users who illegally consume media content. This will allow the media or product owners to maintain their anonymity while still having control and playing an active role in preventing piracy and monetizing their media or products. The inventions of the present disclosure provide these and other benefits and advantages.

### SUMMARY OF THE INVENTION

One objective of the present disclosure is to provide a series of cover sites and straw sites, applications and associated marketing tools that allow the media or product owners to scale and understand, track, visualize and disrupt the piracy and misuse of their media content, goods or products that is occurring.

Another object of the present disclosure is to provide tools that allow media content owners to understand the market, how media content, black or grey and counterfeit market products are consumed or used, so they can make better decisions in product development and marketing, to prevent piracy, to convert users who illegally consume the content to lawful paying consumers and to have positive interactions with these users.

Another objective of the methods of the present disclosure is to allow the media content or product owners to disrupt the search presence and volume that illegal sites rely on through the deployment of multiple sites that are networked together. Among other things, this provides value to media content and product owners by redirecting traffic to legitimate sites while hampering the viability of illegal sites in the ecosystem. The scalable deployment of numerous websites that appear to be illegal also consumes search engine bandwidth, making consumption of illegal goods and media content more difficult to accomplish.

Yet another objective of the methods of the present disclosure is to allow media content and product owners to monitor the marketing efforts of their media content or products in a benign environment and remain completely separate from activities involving the users of such illegal sites. This will allow the media content or product owners to maintain their anonymity while still having control and playing an active role in preventing piracy and monetizing their media or products.

Yet another objective of the present disclosure is to provide systems and methods of deploying various cover sites to a host of offshore or onshore servers to keep media or product owners separate from the users who illegally consume media content. This will prevent security issues for media or product owners and allow them to maintain their anonymity while still playing an active role in the process or understanding their actual, potential customers and users who are illegally consuming their media content or products.

Yet another objective of the present disclosure is to provide systems and methods that include chat management functionality that allows management and delivery of conversations and information regarding the person who the operator/officer is impersonating, IP address and email of suspected criminal.

In accordance with one aspect of at least one embodiment of the present disclosure, the method comprises 1) creating at least one cover or straw site by at least one processor with each cover site created on at least one web server having at least one processor and one network communication channel and running web server software with each cover or straw site comprising of information about media content, goods or products to provide a visitor with the ability to use, access or consume the media content, goods or products by sending a command request to the web server software causing the web server to use the network communication channel to transfer the media content or the information associated with the goods or products from the web server to the visitor; 2) interrupting a visitor's use, access or consumption of the media content, goods or products on the cover sites after a pre-determined amount of time causes a command request to get sent to the web server software causing the web server to terminate the transfer of media content or information via the network communication channel; 3) displaying a message on a display screen associated with the visitor after interruption occurs stating that the visitor's use, access or consumption or the attempted use, access or consumption of the media content, goods or products on the cover or straw site is or would be unauthorized; 4) providing the visitor with the ability to purchase, license, or otherwise obtain authorization to use, access or consume the media content, goods or products; and 5) causing a command request to get sent to the web server software causing the web server to restart the transfer of the media content or information via the network communication channel after authorization has been obtained.

In another aspect of at least one embodiment of the present disclosure, the system of the present disclosure comprises 1) providing or otherwise generating at least one application or cover site through a system that provides visitors of the application, cover or straw site with the ability to search for media content, grey or black market goods counterfeit products or have access to the media content, grey or black market goods or counterfeit products; 2) requesting that visitors sign in or register with the application, cover or straw site when trying to access the media content, grey or black market goods or counterfeit products; 3) collecting information about the visitors; 4) collecting information on how media content, grey or black market goods or counterfeit products are being used or accessed; 5) interrupting visitors' access of the media content, grey or black market goods or counterfeit products by disabling, restricting or blocking such access; 6) displaying a message after the visitor has started using, accessing or consuming media content, grey or black market goods or counterfeit products on the cover or straw site that the visitors that their access to the media content, grey or black market goods, or counterfeit products is unauthorized; and 7) providing the visitors with a choice to purchase or obtain authorization to access the media content, grey or black market goods or counterfeit products.

In another aspect of at least one embodiment of the present disclosure, the system of the present disclosure comprises 1) a storing unit that stores at least one template and module, wherein each template has different layout and each layout includes at least one main section and at least one sub section; 2) a processor that generates at least one cover or straw site by assigning different modules to the main section and sub section of the layout of the templates, wherein the module assigned to the main section of the layout provides visitors of the cover sites with the ability to search for media content, grey or black market goods or counterfeit products and have access to the media content, grey or black market goods or counterfeit products; 3) a collecting unit that collects information about the visitors and collects at least information about how often and in what way the media content, grey or black market goods or counterfeit products are being used/accessed by visitors; 4) an interrupting unit that interrupts visitors' access of the media content, grey or black market goods or counterfeit products; 5) a notifying unit that notifies visitors of the cover or straw sites that their access to media content, grey or black market goods or counterfeit products is unauthorized and provides visitors with choice to purchase or obtain authorization to access the media content, grey or black market goods or counterfeit products; and 6) a redirecting unit that redirects visitors to the lawful media content owners' website or hard goods product owners lawful point of commerce.

In yet another embodiment, the present disclosure provides for anti-counterfeiting techniques relating to users who illegally stream media content using peer-to-many live streaming applications, including, but not limited to, Periscope®, Meerkat®, among others. The methods of the present disclosure create a new streaming channel to interrupt the illegal streams. The present disclosure also provides reports on those who stream in order to provide information to media content owners on who is watching, any contact information available to be collected, and how long each user is watching such stream.

In another embodiment, the cover or straw site comprises the appearance of an ordinary company. This includes, but not limited to, a physical address, phone number, and employee list. The cover or straw site provided for each employee: an email address, phone number, and other contact information to make for easier contact and to add legitimacy.

The foregoing and other objects, features and advantages of the present disclosure are more readily apparent from the detailed description of the preferred embodiments set forth below, taken in conjunction with the accompanying drawings.

### BRIEF DESCRIPTION OF THE DRAWINGS

FIG. 1 is a schematic diagram showing an exemplary embodiment of the present disclosure.

FIG. 2 is a schematic diagram showing an exemplary embodiment of the present disclosure.

FIG. 3 is a schematic diagram showing an exemplary embodiment of the present disclosure.

FIG. 4 is a schematic diagram showing an exemplary embodiment of the present disclosure.

FIG. 5 is a schematic diagram showing an exemplary embodiment of the present disclosure.

FIG. 6 is a schematic diagram showing an exemplary embodiment of the present disclosure.

FIG. 7 is a schematic diagram showing an exemplary embodiment of the present disclosure.

FIG. 8 is a schematic diagram showing an exemplary embodiment of the present disclosure.

FIG. 9 is a schematic diagram showing an exemplary embodiment of the present disclosure.

FIG. 10 is a schematic diagram showing an exemplary embodiment of the present disclosure.

FIG. 11 is a schematic diagram showing an exemplary embodiment of the present disclosure.

FIG. 12 is a schematic diagram showing an exemplary embodiment of the present disclosure.

FIG. 13 is a schematic diagram showing an exemplary embodiment of the present disclosure.

FIG. 14 is a schematic diagram showing an exemplary embodiment of the present disclosure.

FIG. 15 is a schematic diagram showing an exemplary embodiment of the present disclosure.

FIG. 16 is a schematic diagram showing an exemplary embodiment of the present disclosure.

FIG. 17 is a schematic diagram showing an exemplary embodiment of the present disclosure.

FIG. 18 is a schematic diagram showing an exemplary embodiment of the present disclosure.

FIG. 19 is a schematic diagram showing an exemplary embodiment of the present disclosure.

FIG. 20 is a schematic diagram showing an exemplary embodiment of the present disclosure.

### DETAILED DESCRIPTION

The following description is not to be taken in a limiting sense but is made merely for the purpose of illustrating the general principles of the disclosure since the scope of the invention is best defined by the following claims. Various inventive features are described below that can each be used independently of one another or in combination with other features or advantages.

Embodiments of the present disclosure provide methods and systems for providing a series of cover sites and associated marketing tools that allow the media or product owners to scale and understand, track, visualize and disrupt and redirect the potential pirate and counterfeit consumers from the piracy and misuse of their media content, goods or products that is occurring.

For example and not by way of limitation, with respect to scale and understanding, the system will provide product and content owners with the information gathered through tracking and reporting that will give an understanding of the product or media content owners needs to better produce and market their products and how to scale the fight against piracy. With respect to tracking, proprietary analytics are performed on all cover or straw sites that will track and record user interaction within the site along with additional information including, but not limited to, where the user navigated from to get to the cover or straw site. With respect to visualizing and disrupting, a product or content owner will be able to visually see, through data exports and generated reports, the illegal demand for their products and content and be able to react by, and by no means of limitation, 1) developing and marketing a product that is responsive to the information obtained from tracking the activities of the potential pirate consumers, 2) deterring consumption of illegal products or media content by informing potential users who would consume these products or media content of legal actions pursuable for their actions and/or, alternatively, 3) directing potential users who would consume their products or media content to legal methods and portals of product or media content consumption. Users of these websites can be interacted with and tracked by use of their Social Media account. Social Media meaning, for example and not by way of limitation, Facebook®, Twitter®, Google+®, and LinkedIn®, among others.

The methods and systems of the present disclosure also allows media content or product owners to understand the market, how media, black market or counterfeit products are consumed or used to make better decisions to develop and market their media content or products, to deter piracy, to convert users of these cover or straw sites to lawfully paying consumers and to have positive interactions with these users. For instance, and not by way of limitation, owners can generate profits by redirecting the potential users who would consume their products or media content to legit ecommerce websites through the cover or straw sites.

In accordance with one aspect of at least one embodiment of the present disclosure, the method comprises 1) creating at least one cover or straw site by at least one processor with each cover or straw site created on at least one web server having at least one processor and one network communication channel and running web server software with each cover or straw site comprising of information about media content, goods or products to provide a visitor with the ability to use, access or consume the media content, goods or products by sending a command request to the web server software causing the web server to use the network communication channel to transfer the media content or the information associated with the goods or products from the web server to the visitor; 2) interrupting a visitor's use, access or consumption of the media content, goods or products on the cover or straw sites after a pre-determined amount of time causes the cover site to send a command request to the web server software causing the web server to terminate the transfer of media content or information via the network communication channel; 3) displaying a message on a display screen associated with the visitor after interruption occurs stating that the visitor's use, access or consumption or the attempted use, access or consumption of the media content, goods or products on the cover or straw site is or would be unauthorized; 4) providing the visitor with the ability to purchase, license, or otherwise obtain authorization to use, access or consume the media content, goods or products; and 5) causing the cover or straw site to send a command request to the web server software to restart the transfer of the media content or information via the network communication channel after authorization has been obtained.

In another aspect of at least one embodiment of the present disclosure, the method comprises 1) generating at least one cover site through an automatic system that provides visitors that use an application or go to the cover sites the ability to search for media content, grey or black market goods or counterfeit products and have access to at least a portion of the media content, grey or black market goods or counterfeit products; 2) requesting visitors to sign in or register with the application or cover sites when trying to access the media content, grey or black market goods or counterfeit products; 3) collecting information about visitors; 4) collecting information on how media content, grey or black market goods or counterfeit products is being used or accessed; 5) interrupting visitors' access of the media content, grey or black market goods or counterfeit products by disabling, restricting or blocking such access; 6) displaying a message after interruption of the use, access or consumption of the media content, grey or black market goods or counterfeit products on the cover site that the visitors that their access to the media content, grey or black market goods or counterfeit products is unauthorized; and 7) providing visitors with choice to purchase or obtain authorization to access the media content, grey or black market goods or counterfeit products or redirecting the visitors (or potential pirate or counterfeit consumers) from the piracy or misuse of their media content, grey or black market goods or counterfeit products to authorized and legitimate channels of commerce.

In another aspect of at least one embodiment of the present disclosure, the system of the present disclosure comprises 1) a storing unit that stores multiple templates and modules, wherein each template has at least one main section and at least one sub section; 2) a processor that automatically generates at least one mobile application, cover or straw site by automatically assigning different modules to the main section and sub section of the layout of the templates, wherein modules assigned to the main section of the layout provides visitors of the cover or straw sites the ability to search for media content, goods or products and to have access to the media content, goods or products; 3) an information collection unit that collects information about the visitors and collects at least information about how often and in what way the media content, goods or products are being used by visitors; 4) a interrupting unit that disables, restricts or blocks a visitor's use, access or consumption of the media content, goods or products; and 5) a notifying unit that displays a notification on the cover site to visitors of the cover sites after interruption that their use, access or consumption of the media content, goods or products is unauthorized and provides visitors with a choice to purchase or obtain authorization or a license to use, access or consume the media content, goods or products.

For purposes of the present disclosure, media content shall include content, in any form and type, that is or can be protected through law or otherwise. The term “media” can refer to both the physical, such as, but not limited to, CD, DVD or Blu-ray®, among others, and virtual or digital formats, such as, but not limited to, JPEG, Kindle®, EPUB, TXT, RTF, MP2, MP3, AAC, MP4, MOV or AVI, among others, whereas the term “content” can refer to the information or message encoded in a delivery-medium. Examples of media content include, but are not limited to, software, videos, movies, TV shows, music, writings, and any other literary, musical, or artistic work presently available or created in the future. The term “cover or straw site” generally refers to a web page or a display in mobile applications that is generated by the method or system of the present disclosure that includes at least some protected media content, links to access or download protected media content, or mimics the distribution of black or grey market goods or counterfeit products.

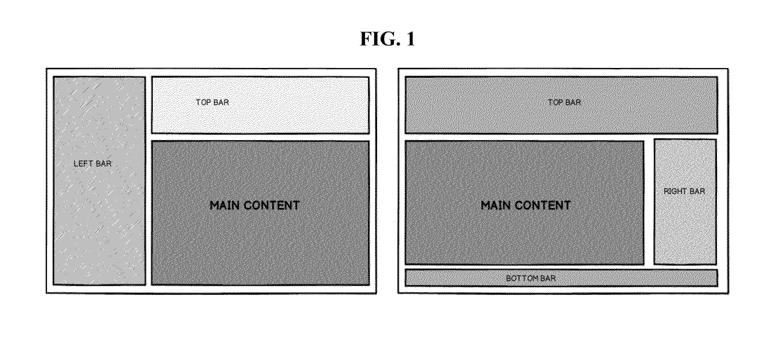

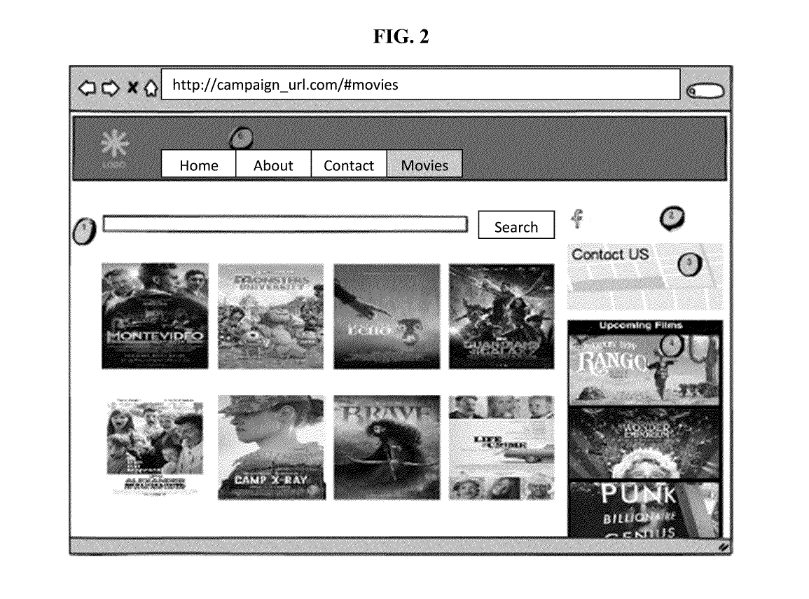

In another embodiment of the present disclosure, at least one cover site is generated by a system. The system includes different templates and modules that can combine with each other to generate different cover or straw sites. As shown in FIG. 1, each template has multiple sections within it such as main content section, top bar section, right bar section and/or bottom bar section. The layout or arrangement of these sections basically determines the view of a cover or straw site (e.g. how a website is presented to a viewer) as shown in FIG. 2.

There are at least two types of modules, a page and a widget, that can be used in the sections of templates. Different modules may have different priority and scope. Each template will use at least one module that has high priority. Each module will also have configuration where it will be defined whether module can be used as a page or widget or both. Note that same module can have more different widgets. For example, items module will have, but not limited to, most recent items and a search items widget, among others.

In yet another embodiment of the present disclosure, each template may have different layouts. Each template will include at least one “placeholders” and one “content holders” where placeholders are usually used for putting main content of a cover or straw site (or a website). For example, each template must have main content block, and that main content block will be used to host pages and main module content.

In yet another embodiment, the present disclosure provides for anti-counterfeiting techniques relating to users who illegally stream media content using peer-to-many live streaming applications, including, but not limited to, Periscope®, Meerkat®, among others. The methods of the present disclosure create a new streaming channel to interrupt the illegal streams. The present disclosure also provides reports on those who stream in order to provide information to media content owners on who is watching, any contact information available to be collected, and how long each user is watching such stream.

In another embodiment, the cover or straw site comprises the appearance of an ordinary company. This includes, but not limited to, a physical address, phone number, and employee list. The cover or straw site provided for each employee: an email address, phone number, and other contact information to make for easier contact and to add legitimacy.

Other sections (low priority sections or content holders) are used for widgets. Widgets can be configured. In one embodiment of the present disclosure, Facebook® like widget or Last 5 Movies widget is assigned to the left bar section and each selected template that has left bar section will show that widget. As such, widgets can be shown on multiple pages. Pages are unique and one module is per one page (with remark that one module can have more pages, for example movies can have search page, details page etc.). As an illustration, the system can provide items module that is configured to display movies (in the items module the movie is configured to have name, image URL, IMDb® URL, description and publishing date. After that, multiple movies with data listed above (name, description, URL, etc.) can be imported from a CSV file.

The page created as a result is placed in a URL, for example, campaign_url.com/#movies, where it displays the main content of the items module (search page with grid for example). As shown in FIG. 2, the cover or straw site (or page) created includes 1) Main Content block/bar—currently start page for movies showed; 2) Facebook® like widget (appears on all pages with right bar); 3) Contact us widget (appears on all pages with right bar); 4) Upcoming movies widget (appears on all pages with right bar); and 5) Menu—special component that will be generated on each page (if template doesn't use it—it will be hidden—for example on Terms and Conditions page). When a user does some interaction with a cover or straw site, (e.g., searches for the movie, clicks on the movie to see details, uses filters criteria etc.) the central block (main content block marked with 1 above) is refreshed and changed. Widgets on the right will remain. Also, in case that same widget bar is used on Contact Us page and when a user goes there, it will show upcoming movies widget, for example.

For example and not by way of limitation, FIG. 2 shows one of the deployed cover or straw sites that makes use of the Facebook® like widget as well as item's content view. This cover or straw site has analytics on the backend not depicted that will provide product and media content owners with essential information that can assist them in understanding consumers' behavior and the market. The product and media content owners can then use the information to combat counterfeiting, piracy and other illicit and illegal activity online, change their marketing methods, and/or advertise their product in a more efficient way. FIG. 2 also displays the separation between product or media content owners and users who would consume their products or media content by keeping any client specific information, other than the clients products or content, from being displayed on the cover or straw site.

Throughout the life of the system, if a new client (media or product owners) comes on, group of templates can be selected based on that client's needs. If there isn't a layout/template that matches their needs, then a new template can be added through some way such as CSS, HTML, etc. Further, the skin of the cover site can also be added, and the cover site may additionally include chat functionality.

Below is a list of exemplary modules that can be used in the present disclosure, but is not to be taken as the only modules available or the only configurations available:

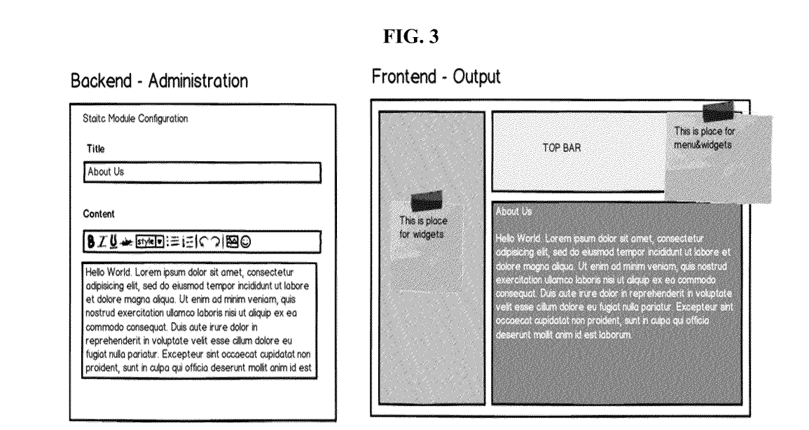

(1) Custom Pages Module: Can be used to, for example and by no way as a limitation, display an “About Us” page, mission or vision page, or terms and conditions. As shown in FIG. 3, this is simple and static text. This module is available as a page only, not as a widget. On the backend side, it will have rich text editor, and on the frontend (campaign) side, it will be displayed as it is entered on the backend side.

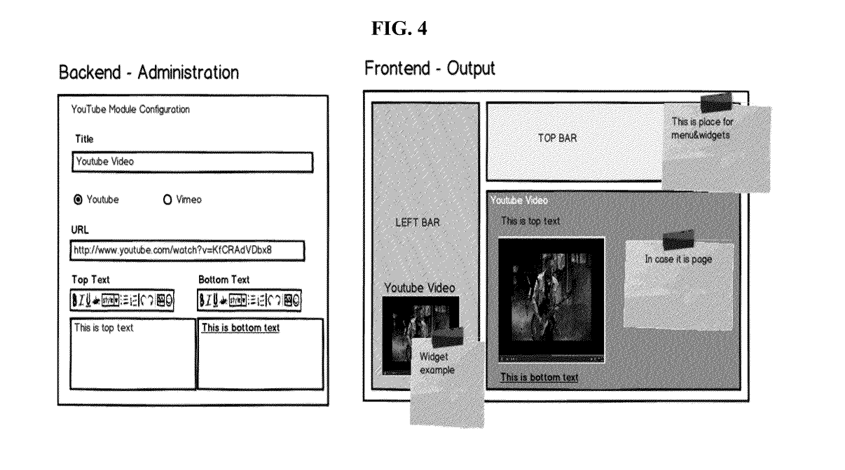

(2) Video Player Module: Can be used to, for example and by no way as a limitation, play video from YouTube®. As shown in FIG. 4, this is a simple video player. It can play content from external sources only. In the backend, user defines certain parameters: Provider (such as, and not limited to, YouTube® and Vimeo®); URL (such as, and not limited to, YouTube® or Vimeo®); Top text; and Bottom text.

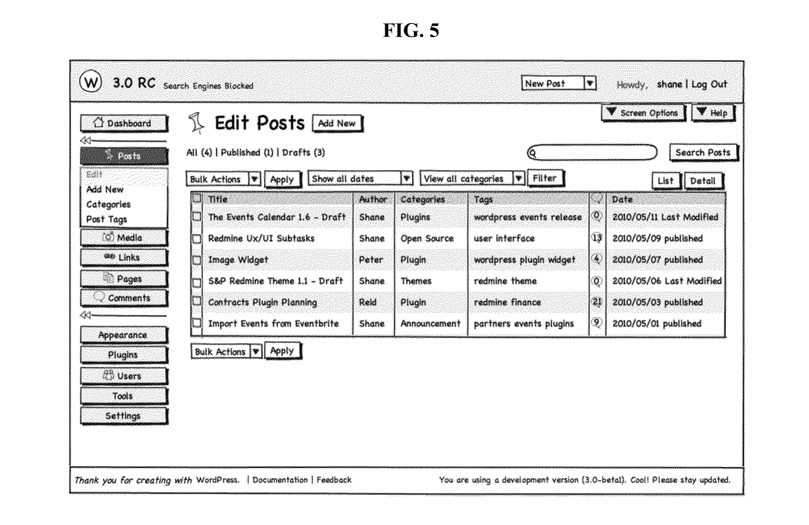

(3) Commenting Module: Can be used to, for example and by no way as a limitation, display comments on videos, pictures, and create forums and Q&A. As shown in FIG. 5, this is a simple commenting box that is either ⅓ page or ⅔ page in width and typically deployed towards the bottom of a page, underneath videos, external links or the items block. It will give visitors to the site the opportunity to communicate with one another, share their opinions, and allow moderators to strike up conversations with visitors. It also has title, option to control comment topics and/or option for admin to interact with visitors.

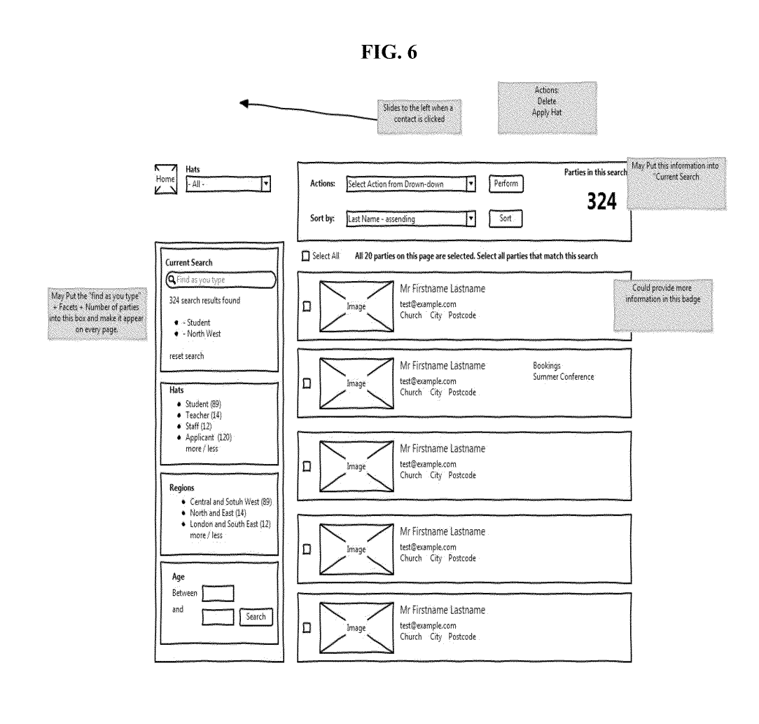

(4) Items Block Module: Can be used to, for example and by no way as a limitation, display videos, TV shows, music, merchandise or fake user profiles. As shown in FIG. 6, this is a simple table layout of multiple items that are hyperlinked to either external websites or subpages on the cover site. Key functionality for allowing visitors to self-select the content they are interested in. It may include, but is not limited to, title, description text, thumbnail images, that are hyperlinked to external pages or sub-pages on the cover site.

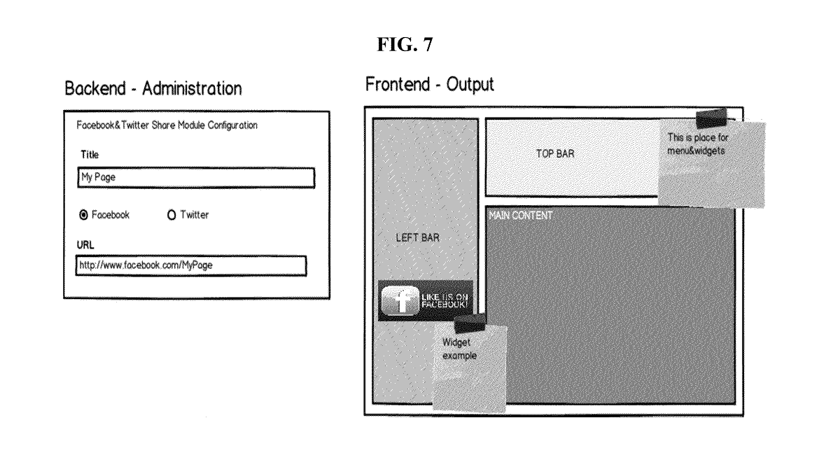

(5) Social Media Share Module: Can be used to, for example and by no way as a limitation, share on Facebook®. As shown in FIG. 7, this is a simple share widget. It shows Facebook®, Twitter®, or other Social Media, as defined above, widgets. In the backend, user defines certain parameters: Type: Social Media and/or Link to share.

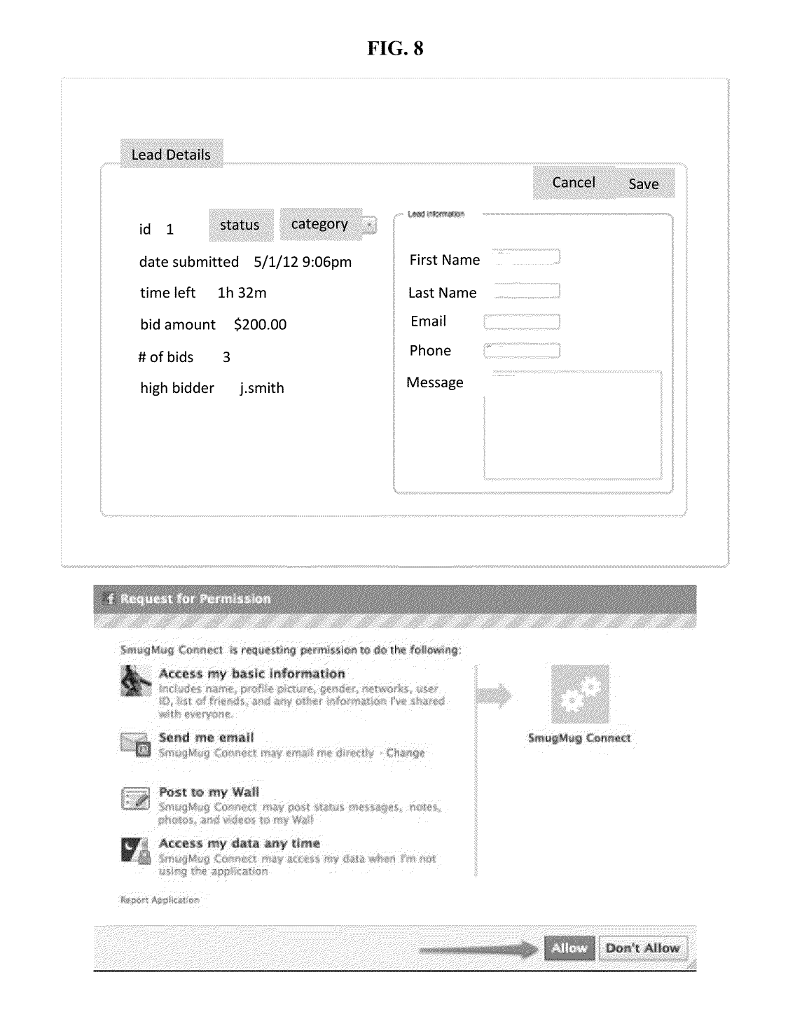

(6) Social Media sign in/registration Module: Can be used to, for example and by no way as a limitation, sign in and register with the cover site via a Social Media login. As shown in FIG. 8, this is a login button that is present on all cover or straw site pages and allows visitors to login with their social media profiles. This is how the system grabs additional demographic information. It can also be a sign up page where a visitor or user's basic profile information can be obtained.

(7) Email sign in/registration Module: Can be used to, for example and by no way as a limitation, sign in and register with the cover or straw site. Email sign-in widget that is most likely present on all pages of a cover site. It includes, but is not limited to: 1) Sign-up: Acquire basic profile information: Name, Email, Username, Password, Age, Gender and 2) Login: Sign-in to Site.

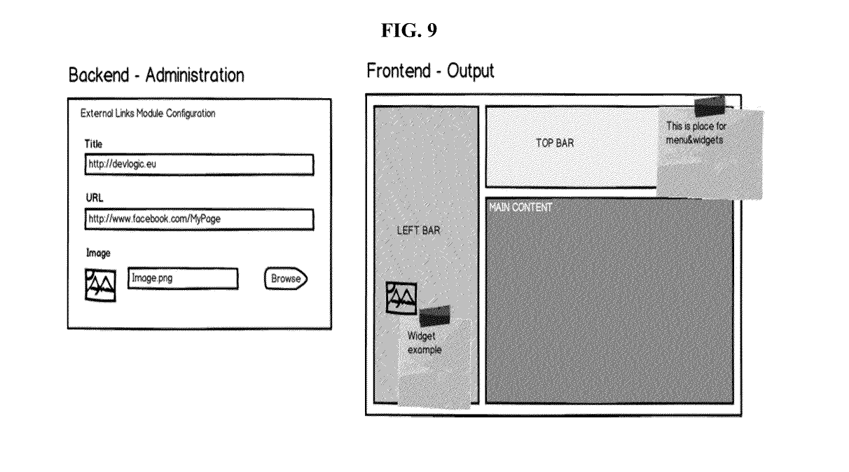

(8) External Links Module: Can be used to, for example and by no way as a limitation, display external links. As shown in FIG. 9, this is a simple link widget. In the backend, user defines, but is not limited to: link URL, title of the link, or image (if link is image).

In one embodiment of the present disclosure, the system comprises, but is not limited to, the following functionality:

Basic Theme Implementation:
Neutral theme that is basic in color scheme and function
Recommend a neutral look to avoid concerns of facilitation of piracy.

List of Movie Titles: implement a
Block of Movie Titles for Homepage
Total Number of Titles=25
Titles will be old releases from pre-1990's.

Movie Title Functionality: Each title will have a sub-page with the following functionality included.
Image of the Film
Film Title
Film Description
Link to corresponding Film IMDb® site/page
Embedded YouTube® Video
   Embedded videos will function as normal, and will be restricted to movie trailers.

Embedded YouTube® Video:
Restrict any embedded YouTube® videos to only show trailers of the Titles included on the site.
YouTube® videos will function as normal to provide a typical user experience.

Restricted Test Site Deployment:
This test site will be deployed on a test server and will only be accessible by designated Disney® team members.

Data Outputs:
Sample output of raw data
Visualization/analyzed output of raw data
1 report of actual data generated by Disney® team members as they visit and view the site.

The above provides for scalable hardware and software, which allows for quickly creating web sites for singular and for multiple purposes. It also allows for the rapid implementation of pirate sites by acquiring pirate sites' exact look and feel and deploy exact or replica websites with a backbone of information gathering or identification tools.

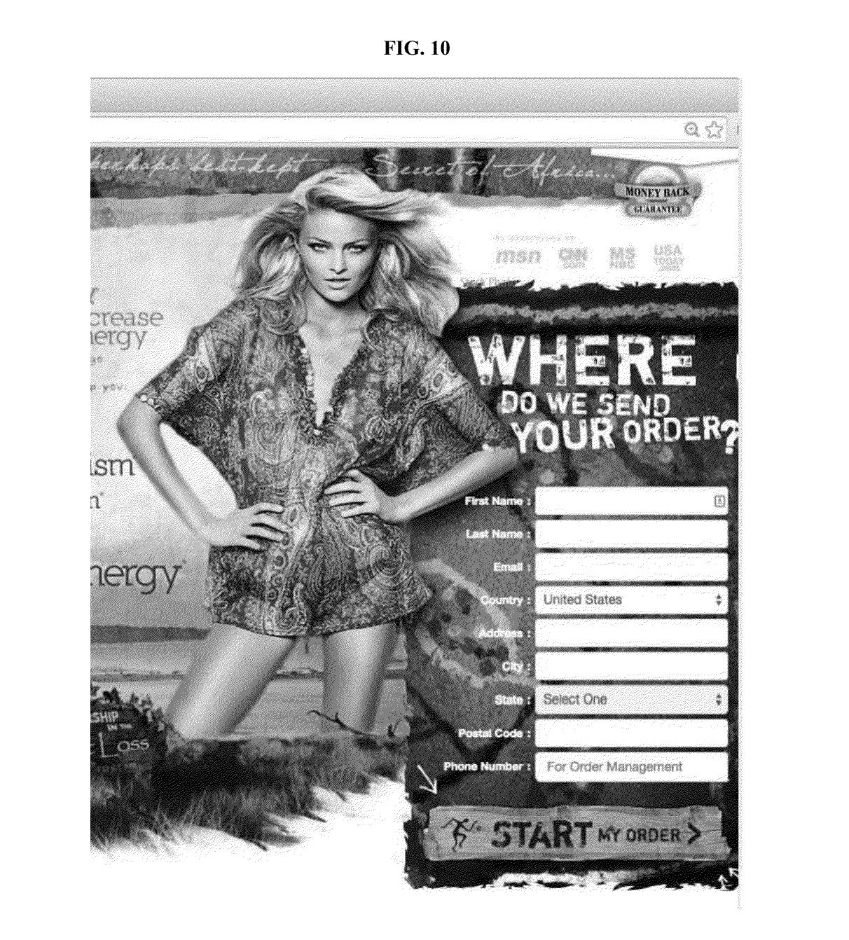

In yet another embodiment of the present disclosure, as shown in FIG. 10, a cover or straw site is built to look like a purchasing site using a template (e.g., brand site template) that includes content specific to a branded product owned by a pharmaceutical company and has a section where user can contact the seller and/or fill the order form. While the visitor is browsing the page, the user is redirect to the official page of the pharmaceutical company (e.g., to pharmaceutical company's shopping cart page). The visitor's information is also recorded when the visitor fill out the order form or when the visitor provides information while attempting contacting the seller. As such, the cover or straw site 1) allows the visitor (or consumer)'s data to be collected (e.g., name, email, address, phone number, location and IP address); 2) allows market education on effects of non-licensed products; 3) allows pirate consumers to convert into legitimate purchaser; 4) allows visits/traffic to current knock-off sites to be reduced; and 5) allows non-licensed purchase activity reduced/diverted.

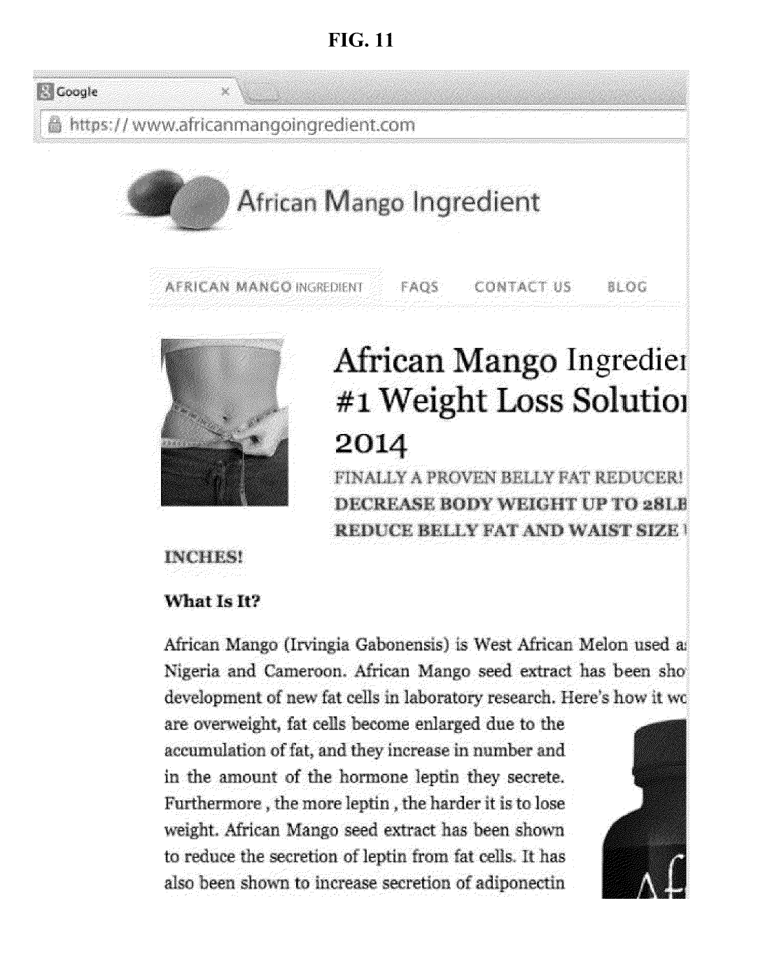

In yet another embodiment of the present disclosure, as shown in FIG. 11, a cover site is built to look like a product promoting blog using a template (e.g., Product Promoting Template). The website includes information that introduces or educates the visitors with particular product(s). The website can further include additional pages (FAQs, Contact, Links), links to other sites, links directly to campaign brand site and other product advertisements. The advantages of such site includes 1) reducing visits to current knock-off traffic; 2) reducing/diverting non-licensed purchasing activity; 3) collecting consumer's information such as IP address; and 4) allowing consumers to funnel to campaign brand site.

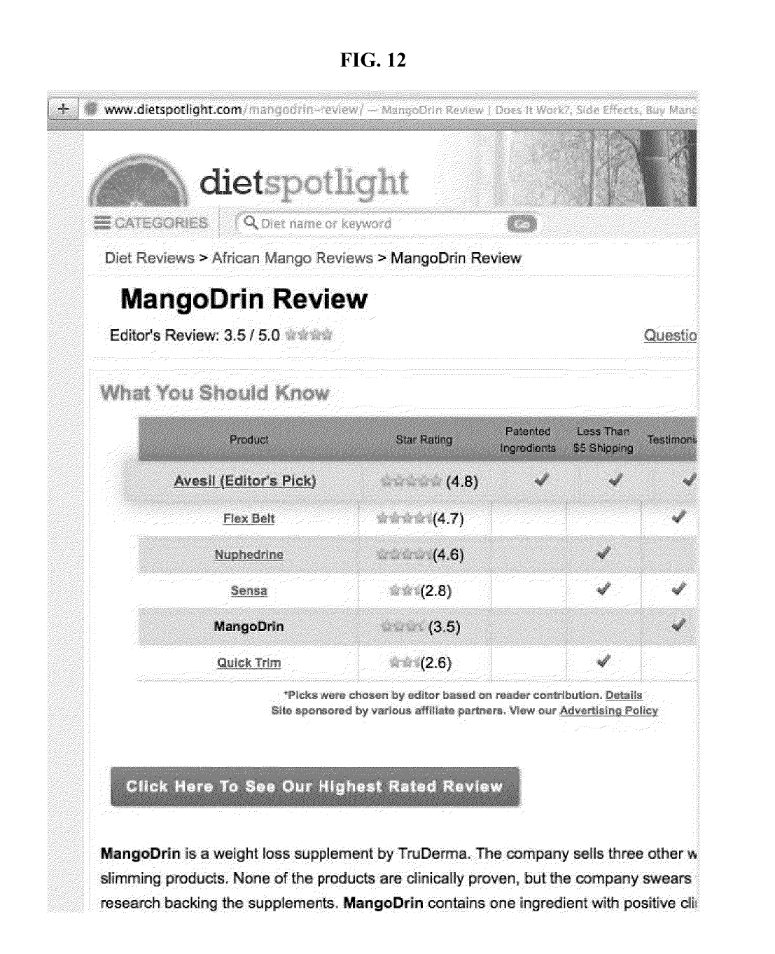

In yet another embodiment of the present disclosure, as shown in FIG. 12, a cover or straw site is built to look like a product review site using a template (e.g., Product Review Template) where the website compares competitive products in the market and includes product reviews. The website also highlights one product (owner or client's product) over others. Similarly, the website can further include additional pages (FAQs, Contact and Links), links to other sites, links directly to campaign brand site and other product advertisements. The advantages of such site also includes 1) reducing visits to current knock-off traffic; 2) reducing/diverting non-licensed purchasing activity; 3) collecting consumer's information such as IP address; and 4) allowing consumers to funnel to campaign brand site.

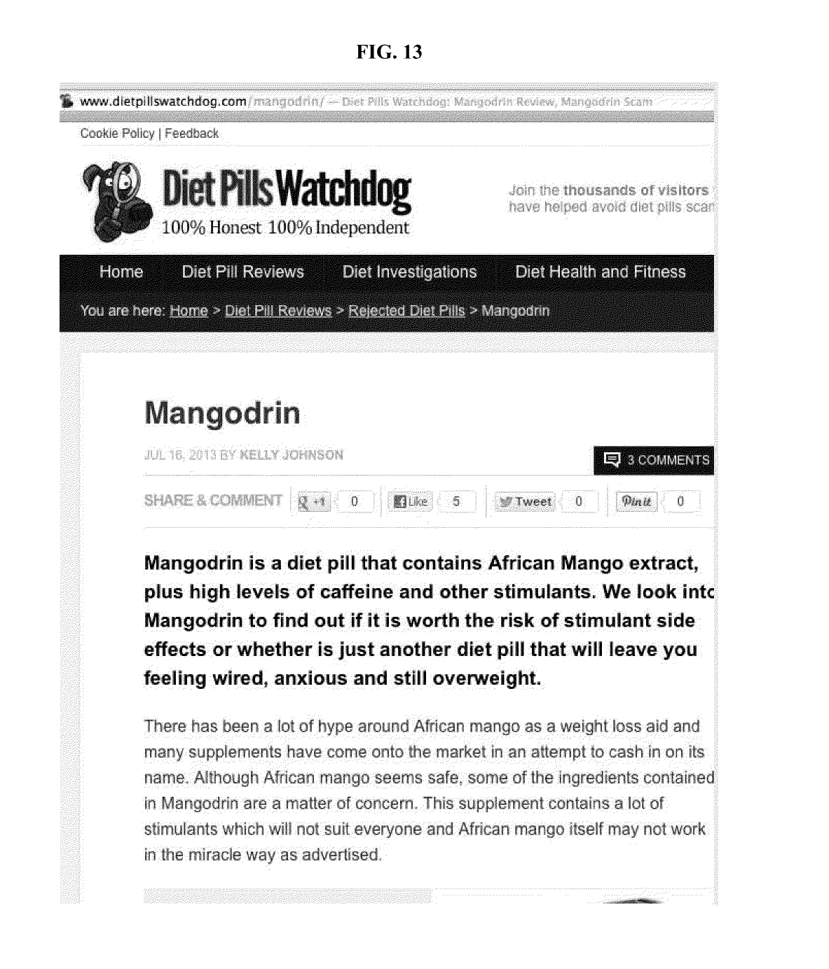

In yet another embodiment of the present disclosure, as shown in FIG. 13, a cover site is built to look like a site introducing approved products using a template (e.g., Approved Product Template) where the website appears to educate consumers on the value of a single approved product over other products in the market. The website is also positioned (or appeared to be) from a non-biased third party. Similarly, the website can further include additional pages (FAQs, Contact, Links), links to other sites, links directly to campaign brand site and other product advertisements. The advantages of such a site also includes 1) reducing visits to current knock-off traffic; 2) reducing/diverting non-licensed purchasing activity; 3) collecting consumer's information such as IP address; and 4) allowing consumers to funnel to campaign brand site.

In yet another embodiment of the present disclosure, the system generating the cover or straw sites can quickly recode and replicate the Cascading Style Sheets (CSS) files of illegitimate sites in order to compete with them in the pirate or counterfeit space almost immediately after their initial deployment.

In one embodiment of the present disclosure, systems and methods of the present disclosure deploy cover sites to a host of offshore or onshore servers to keep media or product owners separate from the users who would consume their products or media content, prevent security issues for the providers or owners and allow them to maintain their anonymity while still playing an active role in the process.

In yet another embodiment of the present disclosure, the cover or straw sites generated by the system of the present disclosure include chat management functionality that allows management and delivery of conversations and information regarding which the operator/officer is impersonating, IP address and email of suspected criminal.

The modular design of the present disclosure allows users to accomplish various tasks.

In yet another embodiment of the present disclosure, the system allows users to quickly self-define website “cover or straw site” appearance based on searching the web, scraping other media, wire frames and quickly replicating them using the offending website's CSS files.

In yet another embodiment of the present disclosure, the system or the cover or straw site allows visitors' information to be collected through modules, such as scalable chat, email address capture, social media login and identification, cellular or landline phone, immediate related public and proprietary data access to create high definition profile and dossier information of visitor.

In yet another embodiment of the present disclosure, the system or the cover site will track each user's purchasing habit and preference. If a user expresses an interest in certain product, the system or the cover or straw site will record it. The system or the server will then generate a self-defined data and email list that contains a list of users who express interest in certain or similar product. The list allows the product owners to advertise other products to these users.

In yet another embodiment of the present disclosure, there is automated SEO modules to control, re-direct, or otherwise control online traffic behaviors within certain traffic groups or other interests groups.

In yet another embodiment of the present disclosure, the cover site has embedded action links that can redirect users to legitimate commerce sites, sell off label, overstock or other marginal interest goods, materials content and services to those seeking to acquire illegal, counterfeited or gray market material while believing the purchase is a bargain or of stolen or pirated goods via deep discounts, promotions, prizes, surveys or other activities.

For example, and not by way of limitation, a user searches online for a black market nutraceutical product or a counterfeit product on a search engine (e.g., Google®) and is directed to one of the cover sites that carries, or pretends to carry, such product. While the user is browsing the cover or straw site, action links embedded in the cover or straw site will redirect the user to a legitimate commerce sites (e.g., Walgreens®) that carries authentic products that the user is looking for. After being directed to the legitimate commerce sites, the user might change his or her mind and decide to purchase the product from the legitimate commerce sites instead. In such instance, a potential user of a black market or counterfeit product is being converted into a lawful purchaser.

In yet another embodiment of the present disclosure, the cover or straw sites provide white label products or authentic products that will soon expire but has competitive pricing as the grey or black market or counterfeit products. For instance, a user searches online for a black market nutraceutical product and is directed to one of the cover or straw sites that carries, or pretends to carry, such black market nutraceutical product. When the user is trying to purchase the black market nutraceutical product from the cover site, the cover or straw site informs the user that the black market nutraceutical product is sold out or unavailable. The cover site then recommends the user to purchase an alternative white label nutraceutical product or authentic product that will soon expire, having the same low pricing as the black market nutraceutical product. If the user follows the recommendation, sales of authentic nutraceutical product will increase, and the owner of authentic nutraceutical product will generate more revenue.

In yet another embodiment of the present disclosure, the present disclosure allows media content owners to interact with content thieves, marginal consumers and those merely browsing to see if contents or goods are available illegally in order to document and experiment with these visitors' behaviors. It allows media or product owners to gain behavior insight into their actions, beliefs, consumption habits and other data in order to market to them, change marketing or piracy strategies based upon such research, or to find out if certain content is stolen or of interest to be stolen in certain regions or formats.

In yet another embodiment of the present disclosure, the present disclosure uses technology to interact with offenders in human trafficking, drugs, prostitution, organized crime and terror radicalization and recruitment online by police or governmental agencies. This interaction will allow the operator to interact with these offenders while collecting data and pedigree information on offenders or targets, leveraging these offenders' false belief of anonymity online. This module will be able to be rapidly deployed and customized by the operator to interact with targets based upon data mining, social engineering and search engine optimization.

In yet another embodiment of the present disclosure, the long term deployments of the present disclosure allows for organic growth of sites that will allow for familiarity and comfort of offenders visiting these sites that will, in turn, widen the popularity of sites and cause those on the top-down distribution side (such as, but not limited to, cartels, terror groups, pimps, gangs or organized crime, among others) to engage the site in order to determine why traffic is going there allowing identification of upstream targets, not just lower level offenders. This will give great insight and guidance to all stakeholders.

In yet another embodiment of the present disclosure, the present disclosure allows for a scalable product to be deployed squeezing out illegal streaming or counterfeiting sites by using multiple deployments frustrating potential pirates of counterfeit purchasers into visiting redirected sites to make legal purchases.

In yet another embodiment of the present disclosure, the present disclosure allows for cover sites and the administration site (Web Admin Site) that manages cover sites to include features as illustrated in Tables 1-3 below:

TABLE 1

| Feature | User | Platform | Description |
|---|---|---|---|
| Email Sign up | System | Web | System Administrator is able to choose whether |
| | Administrator | Admin Site | users of a cover site can sign up via email |
| Social media | System | Web | System Administrator is able to choose whether |
| Sign up | Administrator | Admin Site | users of a cover site can sign up via their social |
| | | | media login |
| Top 10 | System | Web | System Administrator is able to create a top-10 page |
| | Administrator | Admin Site | view |
| Analytics | System | Web | System Administrator is able to pull raw data reports |
| | Administrator | Admin Site | in csv format |
| Analytics | System | Web | System Administrator is able to pull a more |
| | Administrator | Admin Site | processed version of the raw statistics |
| Analytics | System | Web | System Administrator is able to see a visual report |
| | Administrator | Admin Site | on number of visitors for a cover site |
| Analytics | System | Web | System Administrator is able to see a visual report |
| | Administrator | Admin Site | on visitor demographics |
| Analytics | System | Web | System Administrator is able to filter the visual |
| | Administrator | Admin Site | report by several criteria |
| Analytics | System | Web | System Administrator is able to pull a report in |
| | Administrator | Admin Site | Adobe ® PDF format |
| Analytics | System | Web | System Administrator is able to select from a series |
| | Administrator | Admin Site | of visual widgets to include on a reporting dashboard |
| Analytics | System | Web | System Administrator is able to directly email visual |
| | Administrator | Admin Site | data report dashboard to clients |
| Static Video | System | Web | System Administrator can upload videos to cover |
| | Administrator | Admin Site | site campaigns for digital streaming |
| Static Video | System | Web | System Administrator can embed videos from other |
| | Administrator | Admin Site | piracy or streaming video hosting sites. |
| Streaming | System | Web | System Administrator can set up a live streaming |
| Video | Administrator | Admin Site | video feed for cover sites. |
| Webcam | System | Web | System Administrator is able to enable webcam |
| | Administrator | Admin Site | access for Client Agents on cover sites |
| Items Module | System | Web | System Administrator can dynamically label and |
| | Administrator | Admin Site | select which fields will show up on the Items detail |
| | | | page |
| Items Module | System | Web | System Administrator can upload new items module |
| | Administrator | Admin Site | views to the cover sites. |

TABLE 2

| Feature | User | Platform | Description |
|---|---|---|---|
| Items Module | System | Web | Additional Items module templates are created |
| | Administrator | Admin Site | specifically for hard goods and Human Trafficking |
| | | | clients |
| Ecommerce | System | Web | System Administrator can upload items for sale on |
| | Administrator | Admin Site | cover sites |
| Ecommerce | System | Web | System Administrator is able to setup payment portal |
| | Administrator | Admin Site | or checkout cart |
| Ecommerce | System | Web | System Administrator is able to setup multiple |
| | Administrator | Admin Site | payment portals/options (PayPal ®, Amazon ®, cc, |
| | | | among others) |
| Campaign | System | Web | System Administrator can select from multiple |
| Templates | Administrator | Admin Site | templates when creating a cover site campaign |
| Download | System | Web | System Administrator can upload content for |
| Content | Administrator | Admin Site | download through the cover sites (may require login) |
| Pop-Up | System | Web | System Administrator can select and edit that a pop- |
| Window | Administrator | Admin Site | up will occur if a user is trying to click on or view |
| | | | certain content. |
| Pop-Up | System | Web | System Administrator can create a popup that |
| Window | Administrator | Admin Site | contains audio and video |
| SEO | System | Web | System Administrator can optimize individual pages |
| Optimization | Administrator | Admin Site | for search engines like Google ® (keyword, meta |
| | | | tags, description, etc.) |
| SEO | System | Web | System Administrator can optimize items module |
| Optimization | Administrator | Admin Site | detail pages for upload in .csv format |
| SEO | System | Web | System Administrator can create a site map page that |
| Optimization | Administrator | Admin Site | automatically updates and that they can submit to |
| | | | search engines |
| SEO | System | Web | System Administrator can add information tags to |
| Optimization | Administrator | Admin Site | static (not embedded) videos and images for |
| | | | optimization |
| SEO | System | Web | System Administrator can edit key optimization |
| Optimization | Administrator | Admin Site | items like URL structure for entire cover sites from |
| | | | the admin page. |
| Commenting | System | Web | System Administrator can setup comments on a |
| | Administrator | Admin Site | cover site (unmoderated) |
| Commenting | System | Web | System Administrator can approve, disapprove or |
| | Administrator | Admin Site | edit a user's comments. |
| User | System | Web | System Administrator can add, remove, modify and |
| Management | Administrator | Admin Site | reset passwords for client agents |
| User | System | Web | System Administrator can add or restrict access to |
| Management | Administrator | Admin Site | functionality for specific client users. |
| Social Share | End User | Cover Site | An end user is able to like a piece of content (page, |
| | | | image, video, product, girl) |
| Social Share | End User | Cover Site | An end user is able to share/recommend a piece of |
| | | | content (image, video) |

TABLE 3

| Feature | User | Platform | Description |
|---|---|---|---|
| Commenting | End User | Cover Site | An end user is able to comment on certain pieces of |
| | | | content (videos, images, products, etc.) |
| Items Ratings | End User | Cover Site | An end user is able to rate certain content (videos, |
| | | | profiles, products, etc.) |
| Search | End User | Cover Site | An End User is able to search the sites for content |
| | | | relevant to what the user is looking for |
| Chat | End User | Cover Site | An End User is able to participate in a group chat |
| | | | with other users/members on a website page |
| Chat | End User | Cover Site | An End User is able to participate in a private chat |
| | | | directly with the profile on the website page |
| Filter | End User | Cover Site | An End User is able to filter the content by 2 or more |
| | | | categories (genre & year released, gender & age, |
| | | | etc.) |
| Chat | System | Web | System Administrator can control what is available |
| | Administrator | Admin Site | for public/private chat in the items module from the |
| | | | admin page |
| Chat | System | Web | System Administrator can pull a report on all |
| | Administrator | Admin Site | conversations that occurred with one individual user |
| Chat | System | Web | System Administrator can search through a database |
| | Administrator | Admin Site | of chat history to find a specific chat instance |
| General | Client Agent | Web App | Client agent is able to login to its account once an |
| | | | admin has created an account for it |
| Chat | Client Agent | Web App | Client agent is able to open group/private chat |
| | | | conversations on the cover site(s) it manages. |
| Chat | Client Agent | Web App | Client agent is able to manage multiple |
| | | | conversations at the same time. |
| Chat | Client Agent | Web App | Client agent is able to take notes on conversations |
| | | | that it is having with end users. |
| Chat | Client Agent | Web App | Client agent has easy access to details about the |
| | | | profiles that it is impersonating. |
| Analytics | Client Admin | Web | Client admin is able to pull raw data reports in csv |
| | | Admin | format for their sites |
| Analytics | Client Admin | Web | Client admin is able to see a visual report on number |
| | | Admin | of visitors for one of their sites |
| Analytics | Client Admin | Web | Client admin is able to see a visual report on visitor |
| | | Admin | demographics for one of their sites |
| Analytics | Client Admin | Web | Client admin is able to filter the visual report by |
| | | Admin | several criteria for one of their sites |
| Analytics | Client Admin | Web | Client admin is able to pull a report in Adobe ® PDF |
| | | Admin | format for one of their cover sites |
| Deployment | System | Web | System Administrator is able to deploy a new cover |
| | Administrator | Admin | site to a production server |

Below is another embodiment that outlines basic functionality for one system of the present disclosure.

### Proposed Architecture

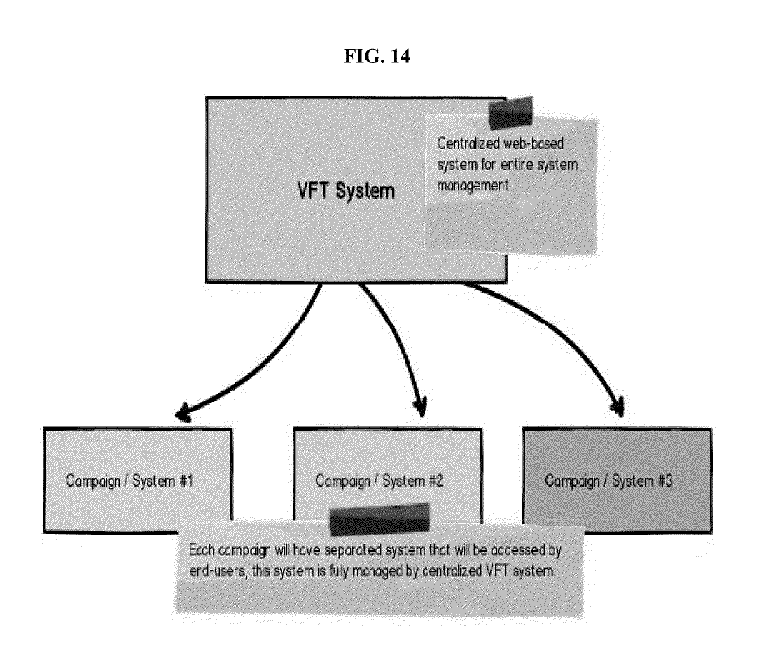

As shown in FIG. 14, from the high level perspective, there is one general and web-based system where all management actions take place. Technically, this system will, based on actions from the users, create and update sub-systems (e.g., campaigns or the campaign website). The system has different areas, such as and no way a limitation: dashboard overview of the actions and alerts; system area that is reserved for system actions like user management, common settings of the system; and the campaigns management core.

The campaigns management core functionality is the place where an administrator can, but is not limited to, create, update or delete campaigns. This includes configuration of the theme that will be used, adjustments of the colors, texts, images, etc. This also includes bulk uploading of the Excel®, CSV or any other (predefined) files that will allow bulk upload of the data (e.g., agency uploads 10 k rows related to the movies data in the CSV file). The campaigns management core is also where the administrator see various reports that include: statistics of the individual modules (e.g., if there is Social Media sign-in module attached, it would display all users registered, when they registered, etc.) General statistics and metrics (needs to be predefined but in general unique visits, geographic areas, platforms, screen resolutions, etc.) The campaigns management core is also where hardware configuration and allocation ability to configure a campaign with or without a load balancer, attach additional instances and automatically scale the configuration.

### Campaigns

Campaign ecosystem will consist of two important components: themes and modules.

With the themes, each campaign will have one theme assigned and that theme is based on predefined (bootstrap based) visual theme that defines high level layout and order of elements (menu appearance/behavior, location of the widgets, main content block, header, footer etc.). Once theme is selected for specific campaign, it is possible to further tweak it and customized it (select logo, different colors, footer, header etc.). Themes will be predefined and user will be able to select a theme during campaign creation. With the modules, modules are predefined/prebuilt functionalities (or widgets/plugins) that will represent some functionality that will be presented to the end-users. Modules will include, but not limited to: custom pages, video player, commenting module, items module, chat module, social media sharing plugins, social media sign in, email sign in or registration, voting and multiple choice popups, external linking, upload functionality, and custom forms functionality, among others.

### Functionality Overview—Mockups

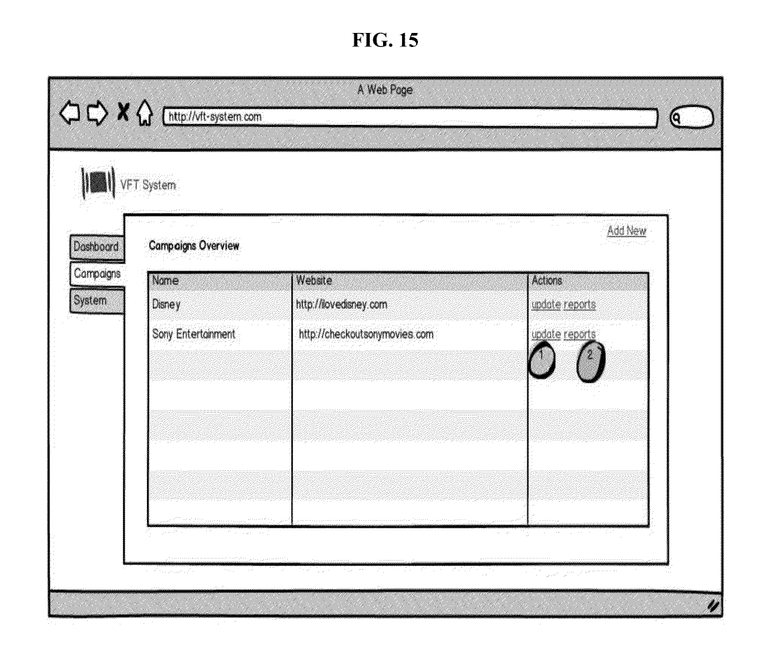

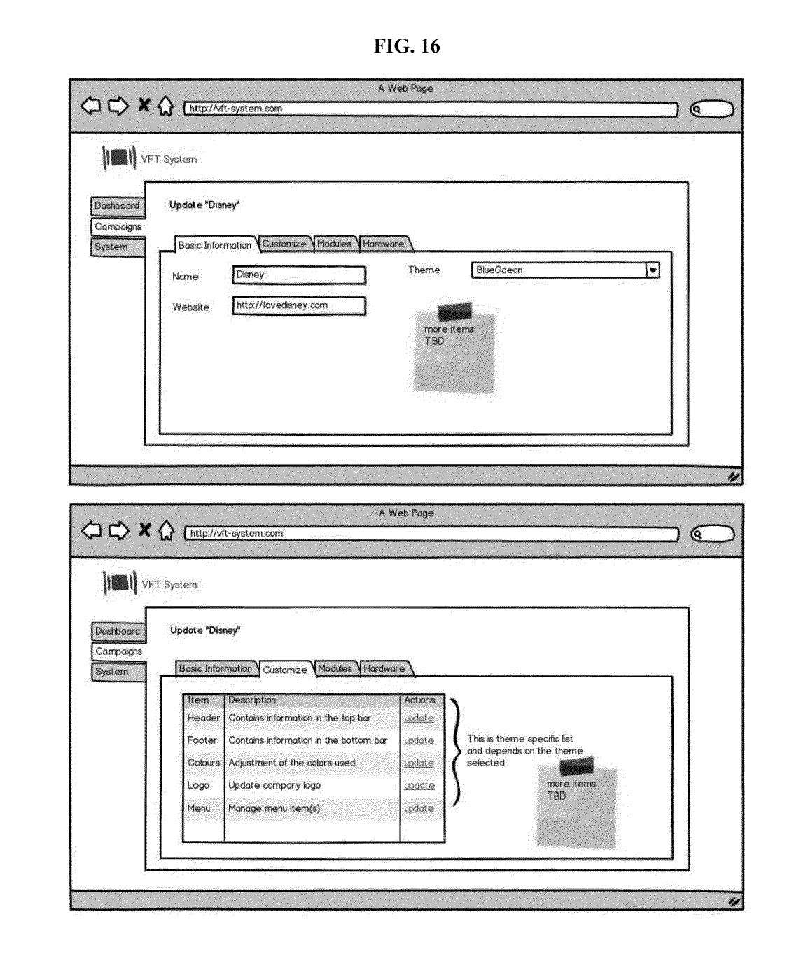

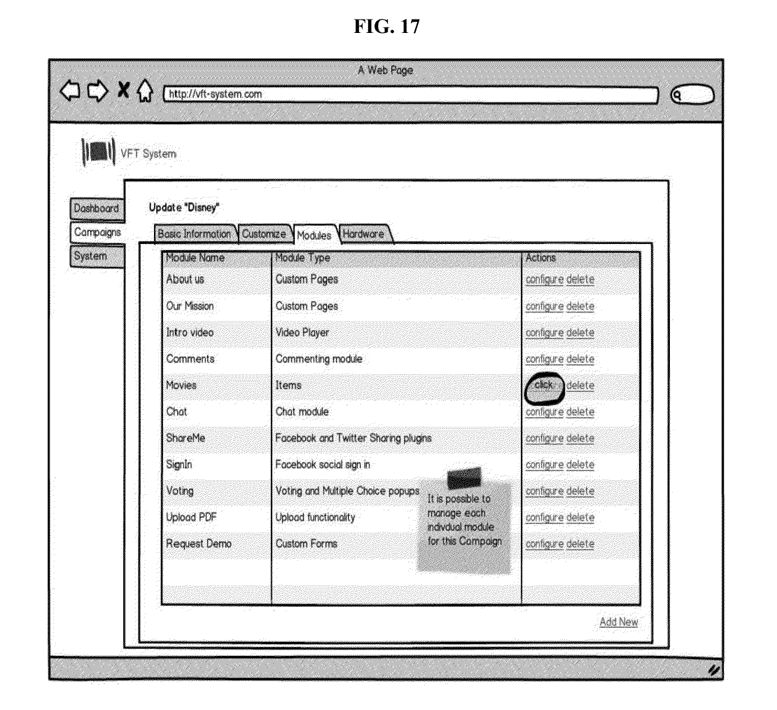

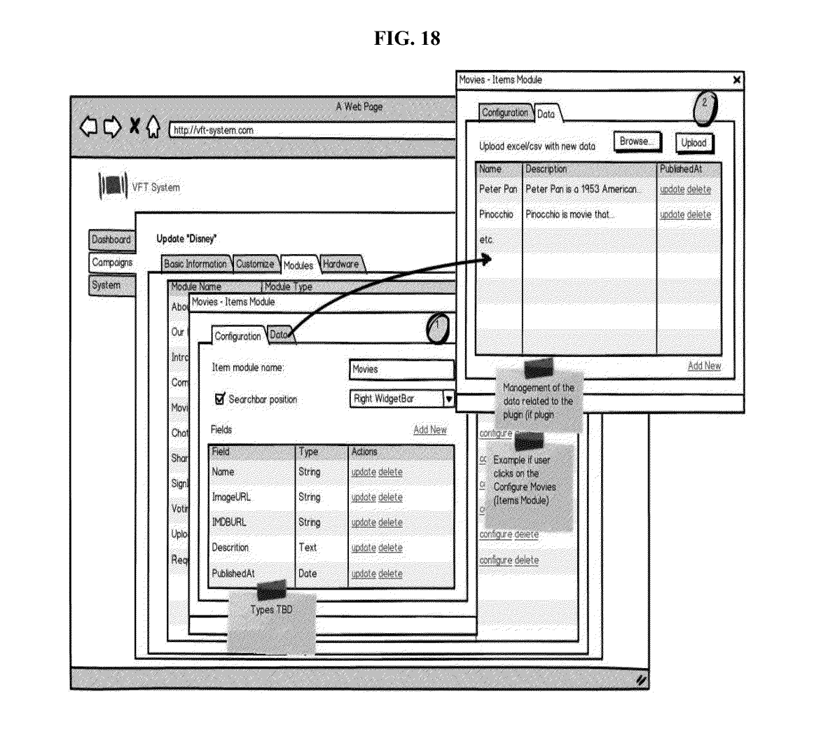

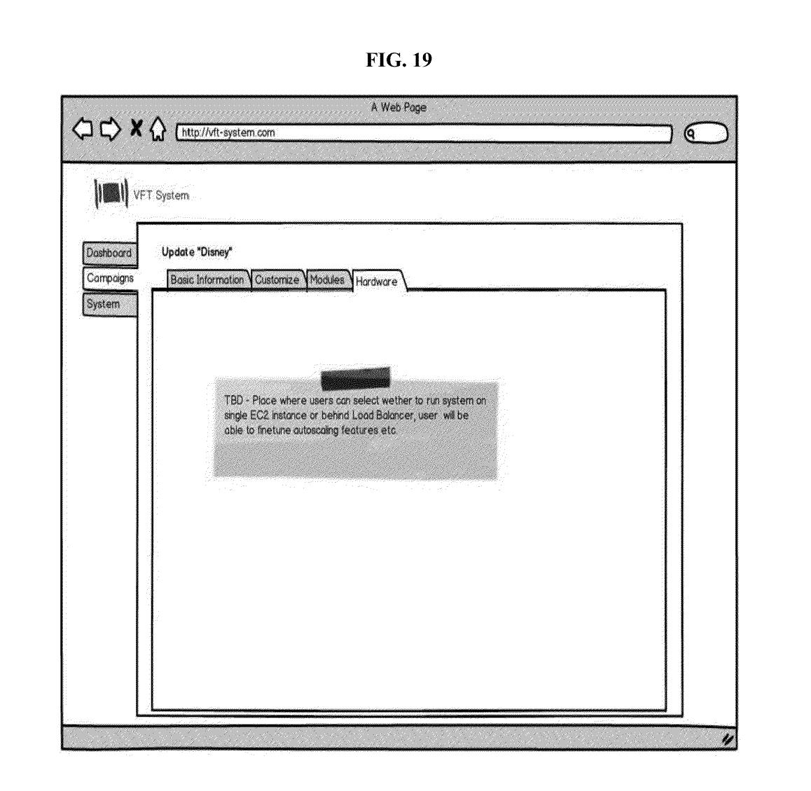

As mentioned, there will be three basic functionalities: Dashboard, Campaigns and System. Campaigns core functionality is to provide an overview of all campaigns on the main screen, and from that screen, a user can go to the Campaign Update page and Reports page as shown in FIG. 15. Campaign Update Page allows a user to change various information related to the campaign, to manage modules and customize theme for campaign. Update Campaign will have 4 basic functionalities: (1) Basic information essential information about the system URL, name, theme selected and other stuff on the campaign level as shown in FIG. 16; (2) Customization part where each theme (selected in the previous step) will have some specific items or blocks (header, footer) and attributes (Logo, Colors, etc.) with all these items being customizable. Different themes will have different parameters (parameters are theme specific) as shown in FIG. 16; (3) Modules for each theme user will be able to add different modules list of modules will be expanded in the future. Modules are pieces of functionality attached to specific part or block defined in the theme. User will be able to get overview of all modules as shown in FIG. 17. Users will also be able to update data related to the module. Each module will have different layout of the update page. As shown in FIG. 18, it has a more complex module called “items” That module allows a user to add the module and defined fields that will be used (example in FIG. 18 shows movies, but this can easily be tweaked to some other item collection like “books”, “songs” etc.) This module has two parts: (a) Configuration of the fields where user can manage fields that will be part of the items (=Movies) data model; (b) Import/Data management of the data within this module. This way the System Admin can define the module “Movies” with some fields and then import Excel® or CSV file with 10,000 movies. These movies will have some functionality for the end-user (Movies Search, Details View, Download, etc.) (4) Hardware Tab, as shown in FIG. 19, this functionality allows administrator/operator (or any other privileged user) to manage and handle allocated hardware resources. Basically for each campaign the operator can allocate cloud storage instances, such as, but not limited to, Amazon EC2® or Windows® Azure® instances (or load balancers) and tweak settings for auto-scaling. This part will also contain notifications in case that usage of the instance reached certain budget, for example. Initial version of the application (Phase #1) assumes usage of the single cloud storage instance for all campaigns.

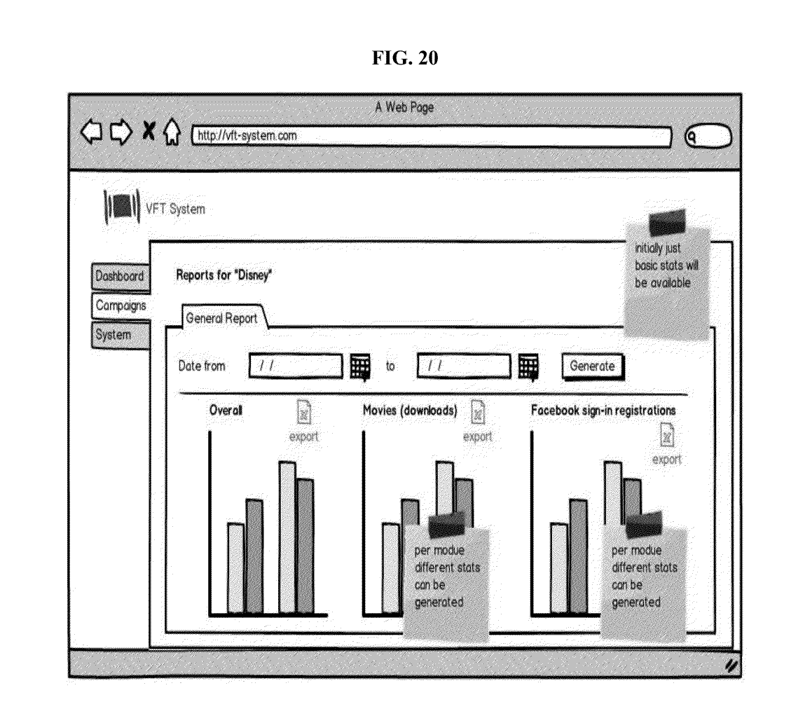

Second major part of the campaign functionality is Reporting, as shown in FIG. 20. System will (initially) have just basic reports: Overall reports for entire system in specific period it will have visits and basic information about users (IP, Browser, Language, Resolution etc.); and specific reports per module (if module supports that) some modules will have statistics, for example, but not limited to: Module items will count number of item downloads, and modules email, sign-in and social media sign-in will count number of users. Each report can be exported to a spreadsheet format, such as, but not limited to, Excel® or Numbers®, among others.

All mockups above illustrate functionality of the management port (system), depending on the campaign selection functionality of the campaigns itself will be different and each campaign will be basically separated system built dynamically and managed through system. It is important to understand that campaign websites will act isolated from the system, and end-users will not have any interaction (functional or technical) with the system.

It should be understood, of course, that the foregoing relates to exemplary embodiments of the disclosure and that modifications may be made without departing from the spirit and scope of the disclosure as set forth in the following claims.

What is claimed is:

1. A method comprising:
using a processor to create at least one cover or straw site with each cover or straw site created on at least one web server having at least one processor and one network communication channel and running web server software with each cover or straw site comprising of information about media content, goods or products to provide a visitor with the ability to use, access or consume the media content, goods or products by sending a command request to the web server software causing the web server to use the network communication channel to transfer the media content or the information associated with the goods or products from the web server to the visitor;
interrupting a visitor's use, access or consumption of the media content, goods or products on the cover or straw sites after a pre-determined amount of time causes a command request to get sent to the web server software causing the web server to terminate the transfer of media content or information via the network communication channel;
displaying a message on a display screen associated with the visitor after interruption occurs stating that the visitor's use, access or consumption or the attempted use, access or consumption of the media content, goods or products on the cover or straw site is or would be unauthorized;
providing the visitor with the ability to purchase, license, or otherwise obtain authorization to use, access or consume the media content, goods or products; and
causing a command request to get sent to the web server software causing the web server to restart the transfer of the media content or information via the network communication channel after authorization to use, access or consume the media content has been obtained by the visitor.

2. The method of claim 1, wherein each of the cover or straw sites has a different appearance.

3. The method of claim 1, wherein the cover or straw sites are accessed through a desktop or mobile web browser.

4. The method of claim 1, wherein the visitor to the cover or straw sites signs in to the cover or straw site using his or her social media sign in information or email and password.

5. The method of claim 1, wherein providing visitors to the cover sites with access to media content includes allowing the user to download media content that is stored in the web server or providing the user with a link to download the media content that is stored at a different location.

6. The method of claim 1, wherein the cover sites have a chat function allowing visitors of the cover sites to interact with each other and with the media content owners or providers.

7. The method of claim 1, wherein notifying visitors that their access to the media content, goods or products is unauthorized includes providing a notification to visitors that evidence of their unauthorized access of the media content, goods or products have been recorded and will be presented to law enforcement if these visitors do not purchase, license, or otherwise obtain authorization.

8. The method of claim 1, wherein the visitors' identities are detected based on their IP addresses, information obtained from their social media or email, or through their conversations with other visitors.

9. The method of claim 1, wherein the visitors are provided with offers, promotions or deals through the cover or straw site or email to use, access or consume the media content or products that the visitors interact or expresses interest in.

10. A system comprising:
a computer storage unit that stores multiple templates and modules, wherein each template has at least one main section and at least one sub section;
a processor that automatically generates at least one mobile application or cover or straw site by automatically assigning different modules to the main section and sub section of the layout of the templates, wherein modules assigned to the main section of the layout provides visitors of the cover or straw sites the ability to search for media content, goods or products and to have access to the media content, goods or products;
an information collection unit that collects information about the visitors and collects at least information about how often and in what way the media content, goods or products are being used by visitors;
a interrupting unit that disables, restricts or blocks a visitor's use, access or consumption of the media content, goods or products; and
a notifying unit that displays a notification on the cover or straw site to visitors of the cover sites after interruption that their use, access or consumption of the media content, goods or products is unauthorized and provides visitors with a choice to purchase or obtain authorization or a license to use, access or consume the media content, goods or products.

11. The system of claim 10, wherein the cover or straw sites are accessed through a desktop or mobile web browser.

12. The system of claim 10, wherein information collected about visitors to the cover or straw sites comprise of the visitors' IP address, social media logins, email logins, information they provided or their conversation with other visitors or administrators.

13. The system of claim 10, wherein the cover or straw sites include chat, live video or audio function allowing visitors to communicate with each other, with administrator of the cover sites or with owner of the media content, goods or products.

14. The system of claim 10, wherein the notifying unit displays a notification to visitors that demonstrates that their unauthorized access of the media content, goods or products has been recorded and will be presented to law enforcement agency if visitors fail to purchase, license or otherwise obtain authorization for the media content, goods or products.

15. A method comprising:
receiving from a visitor to a cover site information that the visitor would like to use, access or consume media content, goods or products;
receiving from a visitor information about the visitor comprising the visitor's IP address, the visitor's current and past use, access or consumption of media content, goods or products on the cover sites, other information identifying the visitor or the visitor's location;
receiving from the visitor information regarding an interest in accessing, viewing or purchasing media content or goods;
determining from the information obtained about the visitor what media content, goods or products the visitor is most interested in using, accessing or consuming;
providing the visitor with the ability to purchase licensed media content or authentic goods or redirecting the visitor to an application or website where the visitor may purchase licensed media content or authentic goods.
